(19) United States
(12) Patent Application Publication
(10) Pub. No.: US 2013/0110568 A1
(43) Pub. Date: May 2, 2013

(54) ASSIGNING WORK ORDERS WITH CONFLICTING EVIDENCES IN SERVICES

(71) Applicants: Winnie W. Cheng, Hawthorne, NY (US); Jia Liu, Hawthorne, NY (US); David Loewenstern, Hawthorne, NY (US); Larisa Shwartz, Hawthorne, NY (US); Vugranam C. Sreedhar, Hawthorne, NY (US)

(72) Inventors: Winnie W. Cheng, Hawthorne, NY (US); Jia Liu, Hawthorne, NY (US); David Loewenstern, Hawthorne, NY (US); Larisa Shwartz, Hawthorne, NY (US); Vugranam C. Sreedhar, Hawthorne, NY (US)

(73) Assignee: International Business Machines Corporation, Armonk, NY (US)

(21) Appl. No.: 13/287,386

(22) Filed: Nov. 2, 2011

(51) Int. Cl. G06Q 10/06

(52) U.S. Cl. 705/7.14

(57) ABSTRACT

A method of recommending an assignment for a work order includes receiving the work order, retrieving information from the work order, identifying a skill set needed to complete the work order using the information retrieved from the work order, extracting, automatically, a first set of evidences from a first data source based on the identified skill set, and a second set of evidences from a second data source based on the identified skill set, combining a first inference and a second inference, by a processor, wherein the first inference is determined using the first set of evidences, the second inference is determined using the second set of evidences, and the first and second set of evidences comprise dissimilar data, and generating a work order assignment recommendation based on the combined inferences.

### BACKGROUND

1. Technical Field

The present disclosure relates to a system and method for assigning work orders with conflicting evidences in services.

2. Discussion of Related Art

In information technology (IT) service delivery environments, assigning a certain person to a job as opposed to another person may affect an outcome, such as labor cost and delivery quality. Typically, dispatchers associated with specific work pools are relied upon to make these decisions using informal knowledge of the broad skill sets of various system administrators, as well as their own experience on how various system administrators have performed certain tasks in the past. With a dynamic global workforce, as dispatchers and system administrators enter and exit organizations, information that can help make these decisions may be lost.

### BRIEF SUMMARY

According to an exemplary embodiment of the present disclosure, a method of recommending an assignment for a work order includes receiving the work order, retrieving information from the work order, identifying a skill set needed to complete the work order using the information retrieved from the work order, extracting, automatically, a first set of evidences from a first data source based on the identified skill set, and a second set of evidences from a second data source based on the identified skill set, combining a first inference and a second inference, by a processor, wherein the first inference is determined using the first set of evidences, the second inference is determined using the second set of evidences, and the first and second set of evidences comprise dissimilar data, and generating a work order assignment recommendation based on the combined inferences.

According to an exemplary embodiment of the present disclosure, an evidence-based recommendation system includes a work order dispatch system, an evidence-based inference engine, and a recommendation system. The work order dispatch system is configured to generate a work order and receive a work order assignment recommendation. The evidence-based inference engine is configured to receive the work order, retrieve information from the work order, identify a skill set needed to complete the work order using the information retrieved from the work order, extract evidences from a plurality of data sources based on the identified skill set, make a plurality of inferences, and combine the plurality of inferences, wherein each of the plurality of inferences is based on one of the plurality of data sources and infers a suitable work order assignment recommendation. The recommendation system is configured to generate the work order assignment recommendation based on the combined plurality of inferences and transmit the work order assignment recommendation to the work order dispatch system.

### BRIEF DESCRIPTION OF THE SEVERAL VIEWS OF THE DRAWINGS

The above and other features of the present disclosure will become more apparent by describing in detail exemplary embodiments thereof with reference to the accompanying drawings, in which:

FIG. 1 is a flowchart showing an overview of an evidence-based recommendation system (EBRS), according to an exemplary embodiment of the present disclosure.

FIG. 2 shows an example of a work order.

FIG. 3 illustrates the assignment of a work order to a bucket, according to an exemplary embodiment of the present disclosure.

FIG. 4 shows a plurality of data sources, according to an exemplary embodiment of the present disclosure.

FIG. 5 shows an evidence-based recommendation system, according to an exemplary embodiment of the present disclosure.

FIG. 6 shows activities assigned to different buckets segmented by complexity, according to an exemplary embodiment of the present disclosure.

FIG. 7 illustrates the evidence-based recommendation system of FIG. 5 making a work order assignment recommendation using DST, according to an exemplary embodiment of the present disclosure.

FIG. 8 illustrates an overview of a process of making a work order assignment recommendation, according to an exemplary embodiment.

FIG. 9 is a computer system for implementing a method of dynamically querying sensor data collections according to an exemplary embodiment of the present disclosure.

### DETAILED DESCRIPTION

Exemplary embodiments of the present disclosure described herein involve assigning work orders to people. For exemplary purposes, embodiments described herein include assigning work orders to people (e.g., system administrators) within an IT service delivery environment. However, the present disclosure is not limited to IT service delivery environments, and may be applied to other fields.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Exemplary embodiments of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

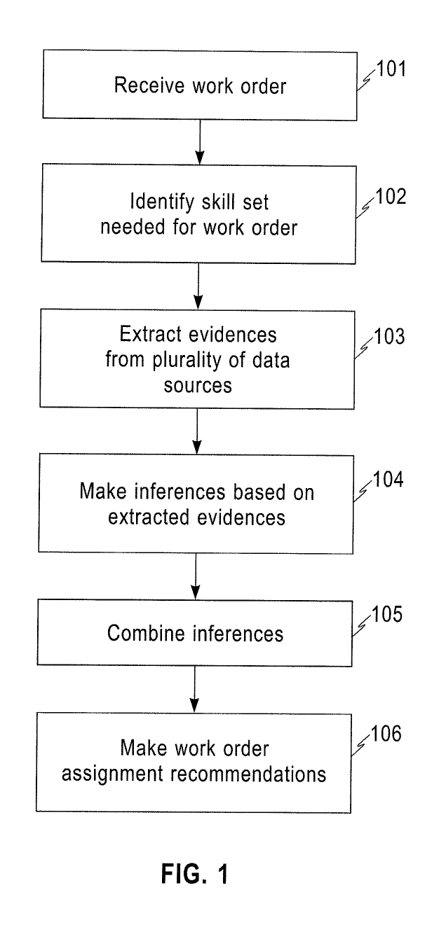

FIG. 1 is a flowchart showing an overview of an evidence-based recommendation system (EBRS), according to an exemplary embodiment of the present disclosure.

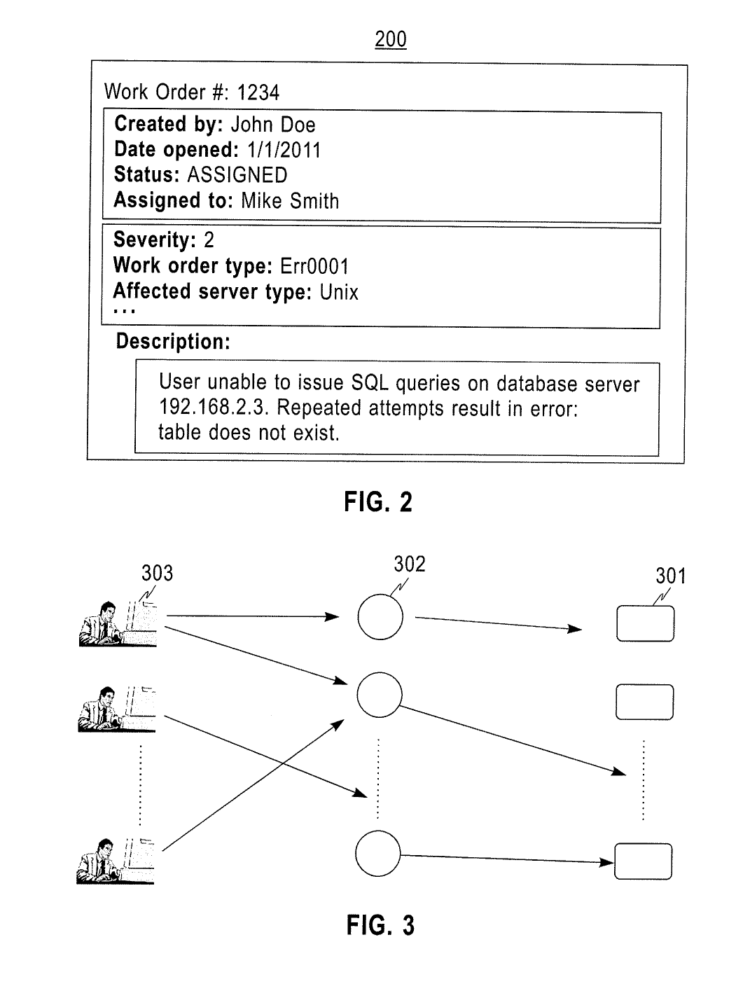

Referring to FIG. 1, an EBRS according to an exemplary embodiment determines the people capable of handling certain work orders in a service environment. FIG. 2 shows an example of a work order 200. Hereinafter, any person in a service environment capable of handling a work order is referred to as a system administrator. To assign a work order to a suitable system administrator, once a work order is received (block 101), a skill set needed for the work order is identified (block 102). The skill set may be identified by performing a retrieval text mining technique on the work order to obtain work order information. The retrieval text mining technique may be, for example, a keyword extraction method based on term frequencies, but is not limited thereto.

The EBRS includes a number of skill pools corresponding to different skill sets, which are hereinafter referred to as buckets. Each bucket includes a logical grouping of system administrators having certain skills. Each bucket includes at least one system administrator having at least one skill of the skill set corresponding to the bucket. A single system administrator may be included in multiple buckets. The number of buckets is assumed to be finite, and the respective skill sets of the system administrators in the service environment are assumed to change infrequently, however the present disclosure is not limited thereto. The buckets may be created, for example, based on input from system administrators, team leaders, or managers within the service environment, or inferred automatically from historical data using feature selection techniques. Once a skill set required for the received work order has been identified, the mined work order information is used to extract evidences from a plurality of data sources (block 103). Inferences are then made based on the extracted evidences (block 104). The inferences made from the evidences of the different data sources are then combined (block 105), and are used to make a work order assignment recommendation (block 106). A work order assignment recommendation includes a recommendation to a assign a work order to at least one system administrator.

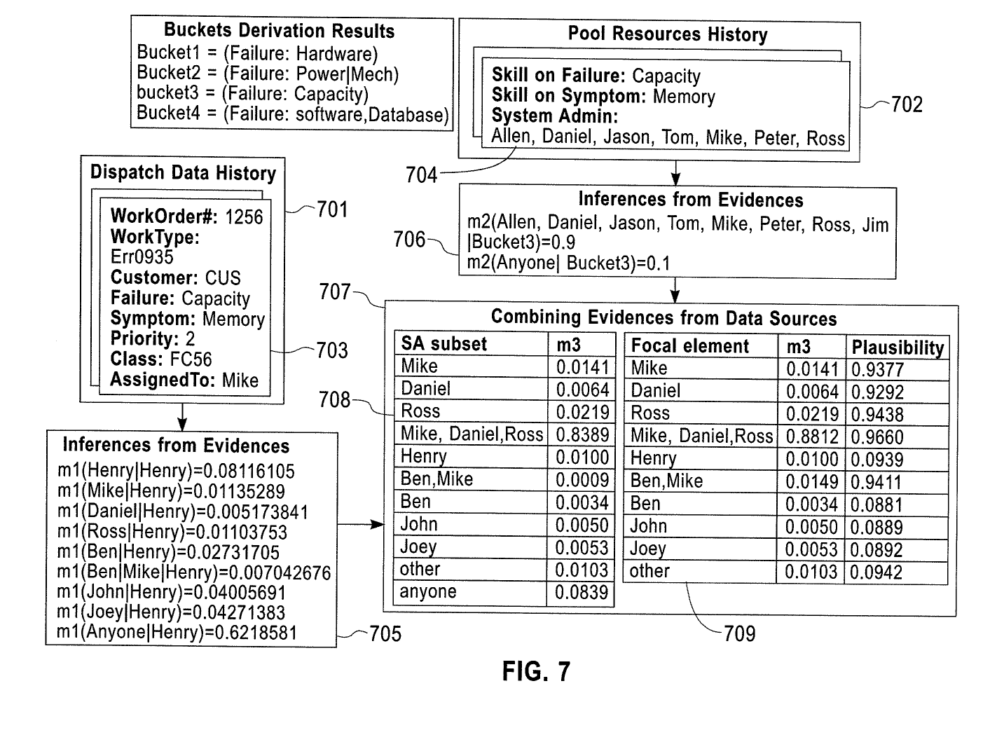

Evidences refer to pieces of information that can be used to determine whether a work order assignment recommendation is satisfactory. Determining whether a work order assignment recommendation is satisfactory based on evidences from a single data source may not result in an accurate determination. For example, if evidences from only a single data source are used, and the quality or accuracy of the single data source is poor, an inaccurate assignment may be made. In exemplary embodiments of the present disclosure, evidences from a plurality of data sources are combined, and a work order assignment is made based on the combined evidences from the plurality of data sources. Using this approach, data sources having poor data quality can be relied upon less than data sources having high data quality, allowing for a more accurate assignment of work orders. A plausibility value and a belief value are determined once the evidences are combined. These values are used to assess the confidence of an assignment. This process is described in more detail below with reference to FIG. 7, as described in more detail below. These determinations aid in assigning work orders to the most suitable system administrators available.

FIG. 3 illustrates the assignment of a work order to a bucket, according to an exemplary embodiment of the present disclosure.

As shown in FIG. 3, one or more work orders 301 are assigned to a bucket 302. As illustrated, the number of buckets 302 is assumed to be finite, however the present disclosure is not limited thereto. Each of the buckets 302 includes at least one system administrator 303. As shown in FIG. 3, a single system administrator 303 may be assigned to more than one bucket 302.

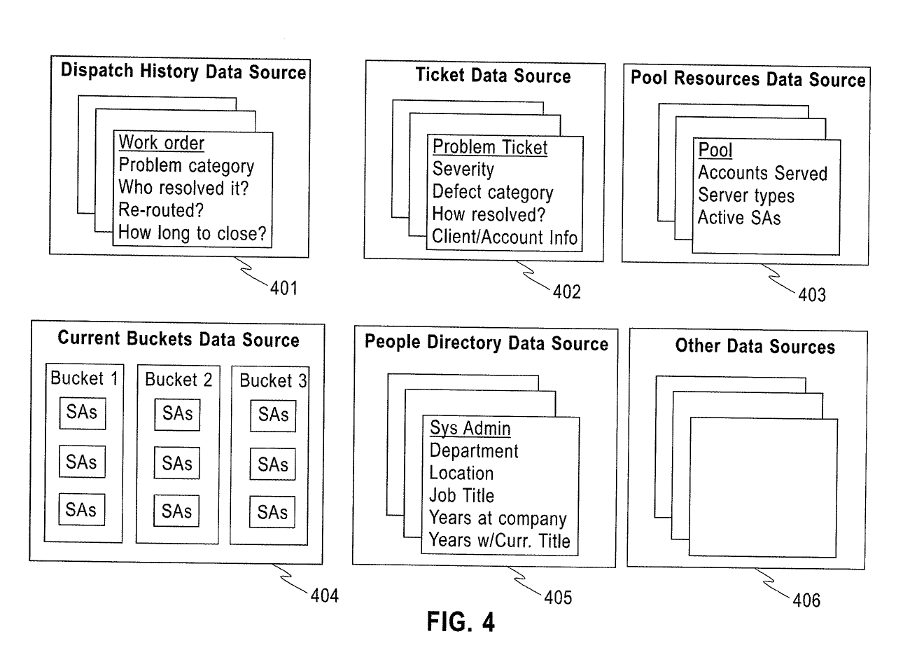

FIG. 4 shows a plurality of data sources, according to an exemplary embodiment of the present disclosure.

As shown in FIG. 4, the plurality of data sources may include, but are not limited to, a dispatch history data source 401, a ticket data source 402, a pool resources data source 403, a current bucket data source 404, a people directory data source 405, and other data sources 406. Each of the data sources include evidences that can be used to assign a work order to a system administrator(s). For example, evidences within the dispatch history data source 401 may include, for example, previous work orders and information indicating how the previous work orders were handled. For example, an evidence within the dispatch history data source 401 may include a description of a previous work order, a category of the work order, an indication of which bucket the work order was classified into, an indication of the system administrator that handled the work order, information indicating whether the work order was re-routed to a different bucket or a different system administrator, and information indicating the amount of time that was taken to close the work order. Evidences within the ticket data source 402 may include previous problem tickets, an indication of the severity of the problem specified in the problem ticket, a category of the problem ticket, information indicating how the problem specified in the problem ticket was resolved, and account information indicating the client that submitted the problem ticket. Evidences within the pool resources data source 403 may include, for example, the account served, server types, and available system administrators. Evidences within the current buckets data source 404 may include a listing of the current buckets in the service environment, as well as a listing of the system administrators in each of the buckets. Evidences in the people directory data source 405 may include profiles of each system administrator in the service environment. A profile may include, for example, a system administrator's department, location, job title, and years of experience.

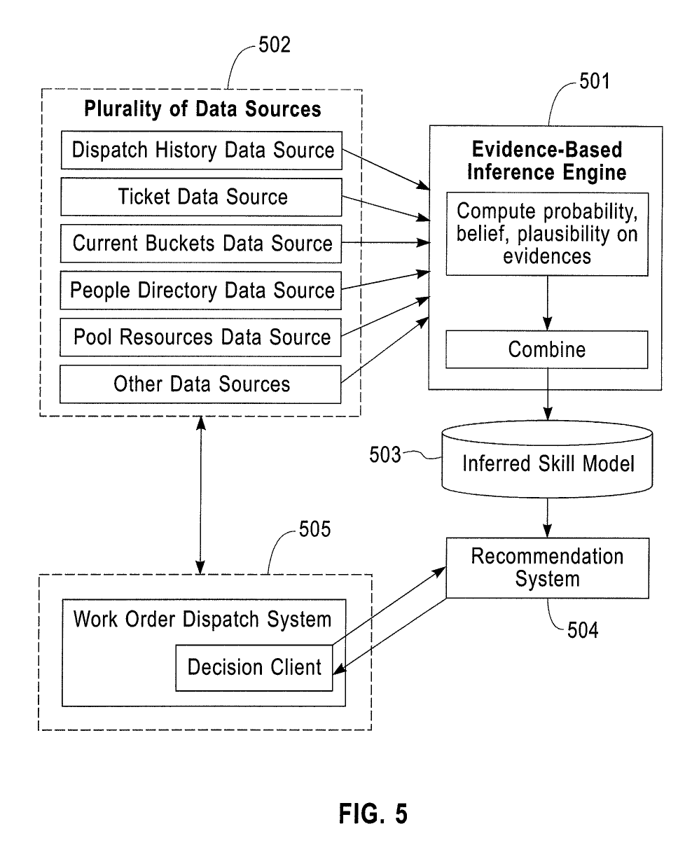

FIG. 5 shows an evidence-based recommendation system, according to an exemplary embodiment of the present disclosure.

As shown in FIG. 5, an evidence-based inference engine 501 is in communication with the plurality of data sources 502 described with reference to FIG. 4. The evidence-based inference engine 501 aggregates evidences from the plurality of data sources 502. Aggregating multiple evidences from a plurality of data sources 502 allows for a more accurate work order assignment recommendation. Once the evidences are combined, an inferred skill model 503 is created and transmitted to a recommendation system 504. The recommendation system 504 then transmits the inferred skill model 503 to a work order dispatch system 505. The work order dispatch system 505 transmits new work orders to the recommendation system 504, and receives work order assignment recommendations from the recommendation system 504.

In an exemplary embodiment, the evidence-based inference engine 501 utilizes the Dempster-Shafer algorithm (DST) to combine evidences from the plurality of data sources 502. Θ represents a finite set of mutually exclusive and exhaustive propositions.

The power set 2^{Θ} is the set of all subsets of Θ including Θ and the null set. Using evidences obtained from the plurality of data sources 502, each subset A, referred to as the focal element, is assigned a numeric value between 0 and 1. A value of 0 indicates there is no belief in a proposition, and a value of 1 indicates that there is total belief in a proposition. DST allows mass probability assignment, or basic probability assignment (BPA) to individual propositions as well as to any subsets. The sum of all BPA is equal to one, and if the probability number for a partial set of a hypothesis is known, the remaining complementary probability value is assigned to Θ, m(Θ), which represents ignorance:

$${\sum }_{A ⋐ Θ} m ( A ) = 1 , m ( φ ) = 0 , wherein φ is the null set$$

In an exemplary embodiment, feature extraction is first performed on the plurality of data sources 502. Each feature provides partial information related to work order characteristics and skill characteristics. The extracted set of features X is then used to determine a set of subsets of features. Each subset is referred to as A. DST may then used to determine a mass function m(A), a belief function bel(A), and a plausibility function pl(A), with the constraint that bel(A) <=m(A) <=pl(A). The mass function m(A) indicates whether an assignment is satisfactory or unsatisfactory, and the belief function bel(A) and the plausibility function pl(A) provide support indicating whether the assignment is satisfactory or unsatisfactory.

For example, using DST, the measure of total belief committed to A is obtained by determining the belief function bel(A), which adds the mass of all proper subsets of A:

$$bel ( A ) = {\sum }_{B ⋐ A} m ( B )$$

bel(A) represents the lower limit of the probability that A is a satisfactory assignment. The plausibility function pl(A) is also determined:

$$pl ( A ) = 1 - bel ( A ) = {\sum }_{B ⋂ A \neq φ} m ( B ) , wherein φ is the null set$$

The difference between the belief function bel(A) and the plausibility function pl(A) represents the ignorance. A new belief function for a focal element C can then be determined from evidences of A and B:

$$m ( C ) = \frac{{\sum }_{A ⋂ B = C} m ( A ) \times m ( B )}{1 - {\sum }_{A ⋂ B \neq ϕ} m ( A ) \times m ( B )} , wherein φ is the null set$$

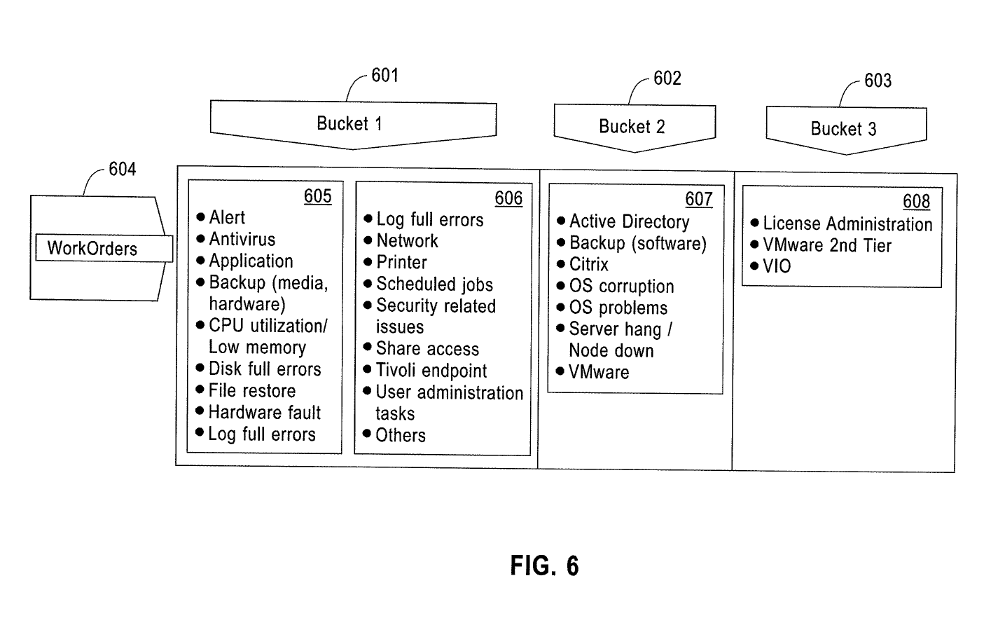

FIG. 6 shows activities assigned to different buckets segmented by complexity, according to an exemplary embodiment of the present disclosure.

The service environment shown in FIG. 6 includes three buckets 601, 602 and 603. Work orders 604 are segmented by complexity. Segmenting the work orders 604 by complexity results in the work orders 604 being routed to the appropriate resource in an appropriately-sized group. This results in balancing the available skills and resources among tasks efficiently, and assigning work orders 604 to system administrators with the needed skills to handle the work orders 604. For example, as shown in FIG. 6, the work orders 604 are segmented into simple groups 605, 606 that are assigned to Bucket 1 601, a more complex group 607 that is assigned to Bucket 2 602, and a most complex group 608 assigned to Bucket 3 603. For projects, different tasks or subsets of activities may be assigned to different individuals in different buckets. FIG. 7 illustrates the evidence-based recommendation system of FIG. 5 making a work order assignment recommendation using DST, according to an exemplary embodiment of the present disclosure.

In FIG. 7, two data sources, the dispatch data history data source 701 and the pool resources history data source 702, are utilized, however additional data sources may also be used. When a work order is received by the evidence-based recommendation system, information is retrieved from the work order and used to extract evidences from each of the plurality of data sources. For example, FIG. 7 shows one of a plurality of evidences 703 extracted from the dispatch data history data source 701, and one of a plurality of evidences 704 extracted from the pool resources history data source 702. Although FIG. 7 only shows one evidence in each of the data sources, it is to be understood that each data source may include a plurality of evidences. The evidence-based inference engine 501 uses the plurality of evidences from each data source to make inferences as to which system administrator(s) is most suitable for the received work order. For example, inferences 705 made based only on evidences 703 extracted from the dispatch data history data source 701 are represented by ml, which shows the basic probability assignment (BPA) of various system administrators for the received work order. Inferences 706 made based only on evidences 704 extracted from the pool resources history data source 702 are represented by m2, which shows the BPA of various system administrators for the received work order.

In FIG. 7, the inferences 705 obtained from the evidences 703 of the dispatch data history data source 701 correspond to a first subset of the entire set of system administrators in the IT service delivery environment. The inferences 706 obtained from the evidences 704 of the pool resources history data source 702 correspond to a second subset of the entire set of system administrators in the IT service environment. Intersecting the first subset 705 and the second subset 706 results in a third subset 708 including a plurality of buckets (e.g., a first bucket including Mike, a second bucket including Daniel, a third bucket including Ross, a fourth bucket including Mike, Daniel and Ross, etc.). Belief and plausibility values for each of the plurality of buckets may be stored, for example, in a table 709. One of the plurality of buckets in the third subset 708 may be recommended for the received work order based on the respective belief and plausibility values of each bucket. For example, if a work order assignment recommendation was made based solely on the first subset 705 (e.g., the inferences 705 from the evidences 703 extracted from the dispatch data history data source 701), the evidence-based recommendation system would recommend assigning the received work order to Henry based on a BPA of 0.565. However, as shown in FIG. 7, intersecting the first and second subsets 705, 706 and combining ml and m2 using DST 707, as described above, yields a BPA m3 that indicates that Mike, Daniel and Ross are equally suitable system administrators for the received work order. Thus, the received work order is assigned to the bucket including Mike, Daniel and Ross. As can be seen in FIG. 7, combining evidences 703 and 704 from data sources 701 and 702 results in a more accurate work order assignment recommendation.

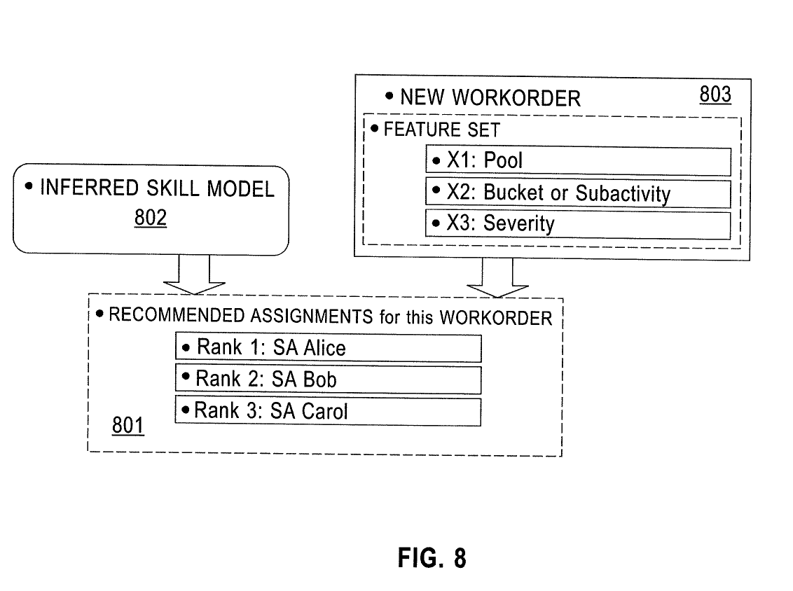

FIG. 8 illustrates an overview of a process of making a work order assignment recommendation, according to an exemplary embodiment. For example, a work order assignment recommendation 801 is based on an inferred skill model 503 generated by the evidence-based inference engine 501 and a work order 802. The work order assignment recommendation 801 may include, for example, a ranking of the most suitable system administrators for the work order 802, as shown in FIG. 8.

The flowcharts and block diagrams in the figures illustrate the architecture, functionality, and operation of possible implementations of systems, methods and computer program products according to various exemplary embodiments of the present disclosure. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

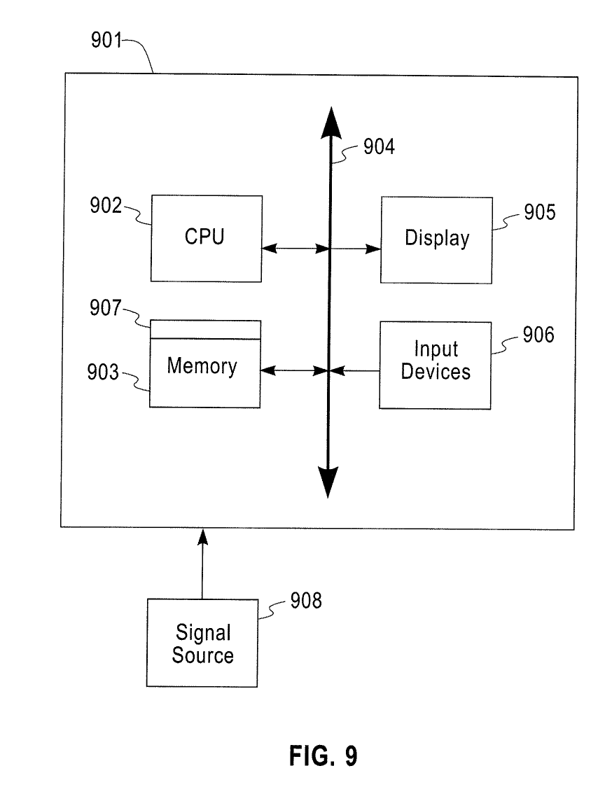

More particularly, referring to FIG. 9, according to an exemplary embodiment of the present disclosure, a computer system 901 for assigning work orders with conflicting evidences can comprise, inter alia, a central processing unit (CPU) 902, a memory 903 and an input/output (I/O) interface 904. The computer system 901 is generally coupled through the I/O interface 904 to a display 905 and various input devices 906 such as a mouse and keyboard. The support circuits can include circuits such as cache, power supplies, clock circuits, and a communications bus. The memory 903 can include random access memory (RAM), read only memory (ROM), disk drive, tape drive, etc., or a combination thereof. Exemplary embodiments of present disclosure may be implemented as a routine 907 stored in memory 903 (e.g., a non-transitory computer-readable storage medium) and executed by the CPU 902 to process the signal from the signal source 908. As such, the computer system 901 is a general-purpose computer system that becomes a specific purpose computer system when executing the routine 907 of the present disclosure. The computer platform 901 also includes an operating system and micro-instruction code. The various processes and functions described herein may either be part of the micro-instruction code or part of the application program (or a combination thereof) which is executed via the operating system. In addition, various other peripheral devices may be connected to the computer platform such as an additional data storage device and a printing device.

Having described exemplary embodiments for a system and protocol for assigning work orders with conflicting evidences, it is noted that modifications and variations can be made by persons skilled in the art in light of the above teachings. It is therefore to be understood that changes may be made in exemplary embodiments of the disclosure, which are within the scope and spirit of the disclosure as defined by the appended claims. Having thus described exemplary embodiments of the disclosure with the details and particularity required by the patent laws, what is claimed and desired protected by Letters Patent is set forth in the appended claims.

1. A method of recommending an assignment for a work order, comprising:
receiving the work order;
retrieving information from the work order;
identifying a skill set needed to complete the work order using the information retrieved from the work order;
extracting, automatically, a first set of evidences from a first data source based on the identified skill set, and a second set of evidences from a second data source based on the identified skill set, wherein each evidence in at least one of the first and second sets of evidence comprises a plurality of different related data categories, and at least one of the first and second sets of evidence comprises data indicative of a previous event;
generating a first set of inferences, by a processor, based on the first set of evidences, wherein the first set of inferences comprises a first subset of a set of system administrators;
generating a second set of inferences, by the processor, based on the second set of evidences, wherein the second set of inferences comprises a second subset of the set of system administrators;
combining the first and second sets of inferences; and
generating a work order assignment recommendation based on the combined sets of inferences.

2. The method of claim 1, wherein the inferences are combined using a Dempster-Shafer method (DST).

3. The method of claim 1, further comprising:
receiving a plurality of work orders;
segmenting the plurality of work orders based on a complexity of each of the work orders; and
assigning the segmented plurality of work orders to a plurality of skill pools.

4. The method of claim 1, wherein the identified skill set is assigned to at least one of a plurality of skill pools having skills corresponding to the identified skill set.

5. The method of claim 4, wherein each of the plurality of skill pools comprises a plurality of system administrators.

6. The method of claim 5, wherein at least two of the plurality of skill pools comprise the same system administrator.

7. The method of claim 5, wherein each of the plurality of skill pools correspond to a different skill set.

8. The method of claim 4, further comprising:
creating, by the processor, the plurality of skill pools, wherein each of the plurality of skill pools is created based on historical data using a feature selection technique.

9. The method of claim 1, wherein the work order assignment recommendation comprises at least one system administrator.

10. The method of claim 1, wherein retrieving information from the work order comprises performing a retrieval text mining technique on the work order.

11. The method of claim 10, wherein the retrieval text mining technique comprises keyword extraction.

12. The method of claim 11, wherein the keyword extraction is based on term frequencies.

13. The method of claim 1, wherein the first and second data sources are disposed remote from the processor.

14. The method of claim 1, wherein one of the data sources is a dispatch history data source comprising a plurality of previous work orders.

15. The method of claim 14, wherein each of the plurality of previous work orders comprises a work order description, a work order category, an assigned skill pool, and an assigned system administrator.

16. The method of claim 1, wherein one of the data sources is a ticket data source comprising a plurality of previous problem tickets.

17. The method of claim 16, wherein each of the plurality of previous problem tickets comprises a problem ticket category, a problem ticket resolution, problem ticket account information, and problem ticket severity.

18. The method of claim 1, wherein one of the data sources is a pool resources data source, and evidences in the pool resources data source include information indicating accounts served, server types, and available system administrators.

19. The method of claim 1, wherein one of the data sources is a current skill pools data source, and evidences in the current skill pools data source includes a listing of current available skill pools and a listing of system administrators in each skill pool.

20. The method of claim 1, wherein one of the data sources is a people directory data source comprising a plurality of profiles corresponding to system administrators.

21. The method of claim 20, wherein each of the plurality of profiles comprises a system administrator's department, location, job title, and experience.

22-25. (canceled)

26. The method of claim 1, wherein:
combining the first and second sets of inferences comprises intersecting the first subset of the set of system administrators with the second subset of the set of system administrators to generate a third subset of the set of system administrators,
and the work order assignment recommendation comprises at least one system administrator from the third subset of system administrators.

27. The method of claim 26, wherein:
the third subset of the set of system administrators comprises a plurality of buckets, each comprising at least one system administrator, and
the work order assignment recommendation corresponds to one of the plurality of buckets.
